(19) United States
(12) Patent Application Publication
(10) Pub. No.: US 2017/0010783 A1
(43) Pub. Date: Jan. 12, 2017

(54) EMERGENCY CALL SMART PHONE APPLICATION

(71) Applicant: THE JOHN AVERY COMPANY, Cudjoe Key, FL (US)

(72) Inventor: Michael BEATTIE, Cudjoe Key, FL (US)

(21) Appl. No.: 15/146,864

(22) Filed: May 4, 2016

Related U.S. Application Data
(60) Provisional application No. 62/189,699, filed on Jul. 7, 2015.

(51) Int. Cl. G06F 3/0481; G06F 3/16; G06F 3/0484; H04M 7/00; H04L 29/08

(52) U.S. Cl. CPC G06F 3/04817; H04M 7/006; H04L 67/306; G06F 3/04842; G06F 3/167

(57) ABSTRACT

The present invention comprises a user network device having a transceiver and a processor operative to display a call for help icon on the network device. Selecting the icon initiates display of an information screen which has populated or fillable loci for a name, phone number, address, an affiliate user name, phone number, address, and a geographical locator icon. Selecting the geographical locator icon creates a geographical location marker for the user network device or for the affiliate user. The processor can initiate a signal containing one of the phone numbers and/or the geographical location markers can to a switch server for analysis to authenticate the number(s) and geocode the location marker(s). A conference call can be initiated to a public safety answering point based on at the signal analysis between at least one of the user network device, the affiliate user and the public safety answering point.

### CROSS-REFERENCE TO RELATED APPLICATIONS

This application claims priority under U.S.C. §119(e) to pending U.S. Provisional Application No. 62/189,699, filed Jul. 7, 2015, titled “911 Smart Phone Application” and is hereby incorporated by reference in its entirety.

### FIELD OF THE INVENTION

The present invention relates to a network device application for wireless communication of a network device user with a public safety answering point (PSAP) and at least one other affiliate application user.

### BACKGROUND

Generally, a person in emergency circumstances requiring the assistance of police, fire department, and/or ambulance services must contact trained telephone operators and/or dispatchers at a public safety answering point (PSAP) via a landline or optionally a mobile device if the location is enabled to receive such calls.

The telephone operator and/or dispatcher is tasked with the responsibility for associating all received landline numbers with an applicable PSAP, often the geographically nearest to the physical address of the landline and/or known address given by the caller. Where a caller initiates communication from a wireless device, this is often difficult because even though wireless service provides are required to have caller location capability, there is no requirement that a PSAP be required to receive caller location from a wireless device.

### SUMMARY

In one aspect of the present invention, a communication network environment, combining local area networks, wide area networks, and wireline networks, wireless networks through the use of user devices, as well as any other environment in network communication and the use of a 911 user device application is described. Mobile computing and communication devices are contemplated to be used in this environment, for example, including but not limited to, a mobile device “smartphone,” wireless-enabled tablet computing device, or any network device with a microphone, speaker and connection to a communication(s) pathway.

In another exemplary aspect of the present network device, the processor can perform further actions, such as, for example, selecting of the icon by the user can initiate display of an information screen further comprising at least one of a populated or a fillable loci for a user name, a user phone number, a user address, at least one affiliate user name, at least one affiliate user phone number, at least one affiliate user address, and a geographical locator icon.

### BRIEF DESCRIPTION OF THE DRAWINGS

The invention and the advantages thereof, may best be understood by reference to the following description taken in conjunction with the accompanying drawings in which:

FIG. 1 illustrates one embodiment of a user entity device that can be included in a system implementing a 911 user device application;

FIG. 2 illustrates one embodiment of communicatively connecting a user, via a user profile in a 911 user device application, to an affiliate user and/or a public safety answering point;

FIG. 3 illustrates a system diagram of one embodiment of a network environment in which a 911 user device application can be implemented; and

FIG. 4 illustrates a logical flow diagram generally showing one embodiment of a process for using a 911 user device application with a user network device.

### DETAILED DESCRIPTION

The present invention, generally, is directed towards a user network device having a transceiver and a processor operative to display a call for help icon on the network device. Selecting the icon initiates display of an information screen which has populated or fillable loci for a name, phone number, address, an affiliate user name, phone number, address, and a geographical locator icon. Selecting the geographical locator icon creates a geographical location marker for the user network device or for the affiliate user. The processor can initiate a signal for analysis to authenticate the number(s) and geocode the location marker(s). A conference call can then be initiated to a public safety answering point based on at the signal analysis between at least one of the user network device, the affiliate user and the public safety answering point.

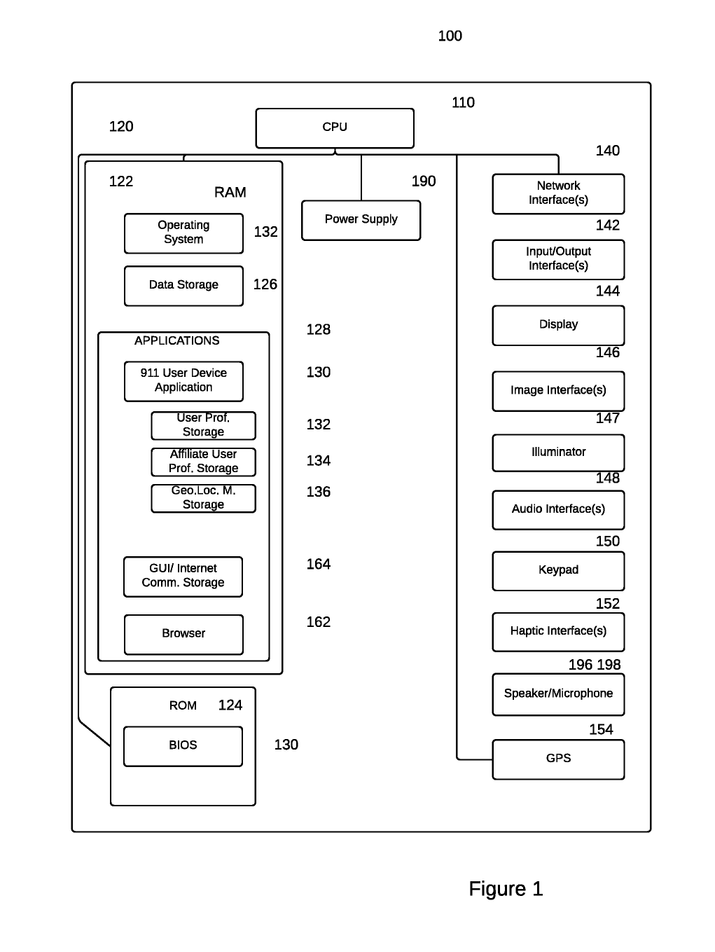

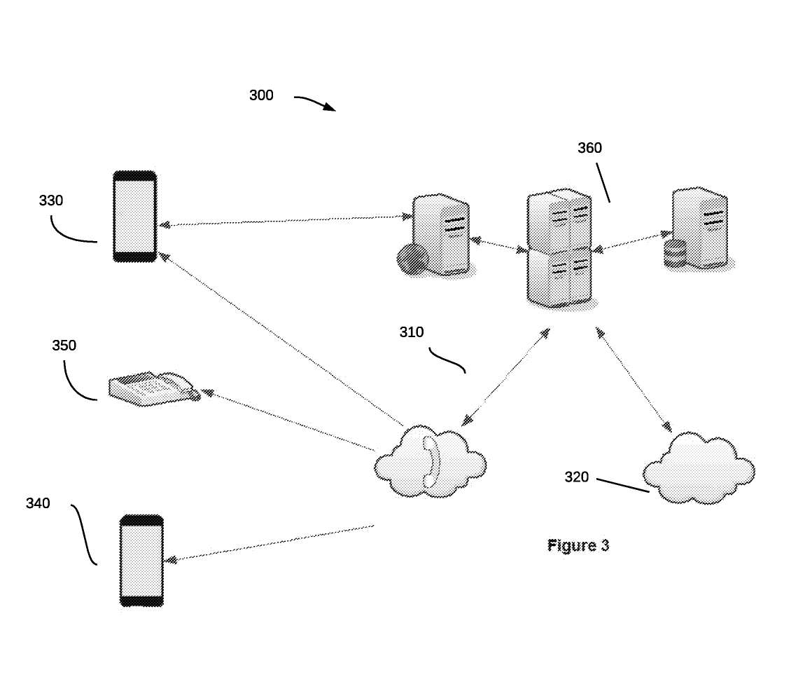

FIG. 1 shows one embodiment of user network device 100 that may be used to implement the inventive 911 user device application. User entity device 100 may include many more or less components than those shown in FIG. 1. However, the components shown are sufficient to disclose an illustrative embodiment for practicing the invention. User network device 100 may represent, for example, one embodiment of at least one of user network device(s) 330 as illustrated below in reference to FIG. 3. At a basic minimum, user network device can be any device with at least one microphone, at least one speaker, and at least one connection accessible to a communication pathway. By way of example, user network device 100 can be, but not limited to, a “smartphone,” a “tablet” device, a desktop computer, a laptop computer, and/or a traditional handset telephone device.

As shown in the figure, user device 100 includes a processing unit (CPU) 110 in communication with a mass memory 120 via a bus 192. Mass memory 120 includes a RAM 122, a ROM 124, and other storage means. Mass memory 120 illustrates an example of computer readable storage media (devices) for storage of information such as computer readable instructions, data structures, program nodules or other data. Mass memory 120 stores a basic input/output system (“BIOS”) 130 for controlling low-level operation of user network device 100. The mass memory also stores an operating system 132 for controlling the operation of user network device 100. It will be appreciated that this component may include a general-purpose operating system such as a version of UNIX, or LINUX™, or a specialized client communication operating system such as Windows Mobile™, Android® operating system, iOS® operating system, or other operating system. The operating system may include, or interface with Java operations via Java application programs.

Memory 120 further includes one or more data storage 126, which can be utilized by user network device 100 to store, among other things, applications 128 and/or other data. For example, data storage 126 may also be employed to store information that describes various capabilities of user network device 100. The information may then be provided to another device based on any of a variety of events, including being sent as part of a header during a communication, sent upon request, or the like. Data storage 126 may also be employed to store 911 user application interface information including user profile information, affiliate user profile information, or the like. Further, as illustrated, data storage 126 may also store information about the 911 user application interface. At least a portion of the information may be stored on a disk drive or other computer-readable storage device (not shown) within user network device 100 or which may be externally connectable.

Applications 128 may include computer executable instructions which, when executed by user network device 100, transmit, receive, and/or otherwise process data relating to the 911 user application, other device functions, for example, such as messages, audio, video, and enable telecommunication with an affiliate user or another user of another user device. Other examples of application programs include calendars, search programs, email clients, IM applications, SMS applications, VoIP applications, contact managers, task managers, transcoders, database programs, word processing programs, security applications, spreadsheet programs, games, search programs, and so forth.

In one embodiment of applications 128, for example, one application can be 911 user device application 130, which can optionally include a user profile storage 132, an affiliate user profile storage 134, and a geographical location marker storage 136. 911 user device application 130 can optionally function with other internal and external components, via communication to remote servers and or server centers, and/or peripherals of user network device 100, to complete operatively integrate features of GPS 154. Integration of features may include, for example, but are not limited to, creating a geographical location marker for a user network device 100 and/or affiliate user, storing such location marker in geographical location marker storage 136, and/or modulating a signal comprising such identified location market to be transmitted externally to a remote switch server or server center, as described more fully below.

Storages 132, 134, 136 can optionally be integrated features of data storage 126, and/or, a separate and individual storage elements as needed, depending on the operating system in use on user network device 100. In additional embodiments, storages 123, 134, 136 do not need be storage elements, but instead may function as add-in features connecting 911 user device application 130 to a remote network device (not shown) which contains said user and affiliate profile data and said geographical location marker data and/or storage of such.

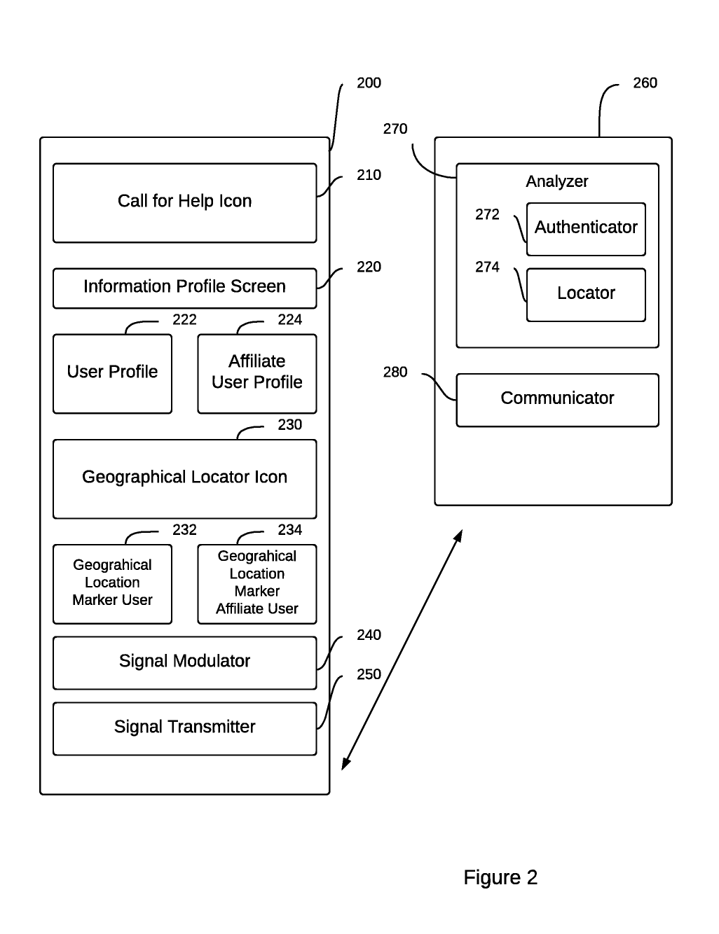

How 911 user device application 130 features described herein, specifically elements 132-136, and so such features are operatively instructed by CPU 110 to complete the application tasks, methodology of computer executable instructions, and other general functionality shall be described in greater detail below, in reference to FIG. 2.

Furthermore, applications 128 may include, for example, browser 162 and internet connectivity storage 164. Browser 162 may include virtually any application configured to receive and display voice signals, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperTest Markup Language (HTML), eXtensible Markup Language (XML), and the like, to display and send voice and/or text signals and data messages. However, any of a variety of other web-based languages may be employed.

In one embodiment, browser 162 may be configured to enable access to a graphical user interface and/or internet connectivity storage 164. In one embodiment, the user interface may be employed by a user of user network device 100 to create and/or enter profile information, create and/or enter affiliate user profile information, create geographical location markers, review and manage user preferences, and/or other aspects of creating, managing and storing user and affiliate user data.

User network device 100 also includes a power supply 190, one or more network interface 140, an input/output interface 142, a display 144, an image interface 146, an illuminator 147, an audio interface 148, a keypad 150, another haptic interface 152, and an optional global positioning systems (GPS) receiver 154. Power supply 190 provides power to user network device 100. A rechargeable or non-rechargeable battery may be used to provide power. The power may also be provided by an external power source, such as an AC adapter or a powered docking cradle that supplements and/or recharges a battery.

User network device 100 may optionally communicate with a base station (not shown), or directly with another computing device. Network interface 140 includes circuitry for coupling user network device 100 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UEB), IEEE 8022.16 Worldwide Interoperability for Microwave Access (WiMax), SIP/RTP, or any of a variety of other wireless communication protocols. Network interface 140 is sometimes known as a transceiver, transceiving device, or network interface card (NIC).

User network device 100 also comprises input/output interface 142 for communicating with external devices, such as a headset, or other input or output devices not shown in FIG. 1. Input/output interface 142 can utilize one or more communication technologies, such as USB, infrared, Bluetooth™, radio frequency identification (RFID), near field communication (NFC) or the like.

Display 144 may be a liquid crystal display (LCD), gas plasma, light emitting diode (LED), or any other type of display used with a computing device. Display 144 may also include a touch sensitive screen arranged to receive input from an object such as a stylus or a digit from a human hand.

Image interface 146 is arranged to produce and receive image data signals, for example, pictures, video, and the like. For example, image interface 146 may include an image recording element (not shown), such as a camera, lens, video, or other image capture element. Image interface 146, can also optionally include an image display element (not shown), for displaying an image created via the image recording element or transmitted to the user network device 100. Illuminator 147 may remain provide a status indication and/or provide light. Illuminator 147 may remain active for specific periods of time or in response to events. For example, when illuminator 147 may backlight these buttons in various patterns when particular actions are performed, such as dialing an affiliate user device and/or a PSAP. Illuminator 147 may also cause light sources positioned within a transparent or translucent case of user network device 100 to illuminate in response to actions. In additional embodiments, it is contemplated that illuminator 147 may cause light sources positioned within user network device 100 to illuminate specifically in response actions taken by those who are not the user of the user network device 100, for example, in response to actions taken by an affiliate user, a dispatcher at a PSAP, and/or a first responder. Audio interface 148 is arranged to produce and receive audio signals such as sound of a human voice. For example, audio interface 148 may be coupled to a speaker 196 and microphone 198 to enable telecommunication with other and/or generate an audio acknowledgement for some action. In additional embodiments, it is contemplated that audio interface 148 is configured to produce and receive audio signals without action by a user of user network device 110, for example, but in response to actions taken by an affiliate user, a dispatcher at a PSAP, and/or a first responder. Keypad 150 may comprise any input device arranged to receive input from a user. For example, keypad 150 may include a push button numeric dial, or a keyboard. Keypad 150 may also include command buttons that are associated with selecting and sending images. Optionally, keypad 150 may a visual display feature integrated into display 144, and/or be an application 128 which operates as described above. Haptic interface 152 may be employed to vibrate client device 100 in a particular way when another user of a computing device is calling, an image is received, or for use with any other functionally necessary feature as required. In additional embodiments, it is contemplated that haptic interface 152 be configured without action by a user of user network device 110, for example, but in response to actions taken by an affiliate user, a dispatcher at a PSAP, and/or a first responder.

GPS transceiver 154 can determine the physical coordinates of user network device 100 on the surface of the Earth, which typically outputs a location as latitude and longitude vales. GPS transceiver 154 can also employ other geo-positioning mechanisms, including, but not limited to, triangulation, assisted GPS (AGPS), E-OTD, CI, SAT, ETA, BSS or the like, to further determine the physical location of user network device 100 on the surface of the Earth. It is understood that under different conditions, GPS transceiver 154 can determine a physical location within millimeters for user network device 100; and in other cases, the determined physical location may be less precise, such as within a meter or significantly greater distances. In one embodiment, however, mobile device may through other components, provide other information that may be employed to determine a physical location of the device, including for example, a MAC address, IP address, or the like. Furthermore, in additional embodiments it is contemplated that GPS transceiver 154 be in communication with a remote server and/or server center, or the like, and affiliate user and/or other user device(s) to act as secondary or assistant location sources, such that a PSAP or first responder can obtain additional location information, as necessary.

FIG. 2 illustrates one embodiment of communicatively connecting a user, through a user profile, to an affiliate user and a public safety answering point (PSAP), as an operation of user device application 200. All elements of application 200 can be operable independently, concurrently or via connection to both internal and external computing elements, which not be shown in FIG. 2.

Call for help icon 210 can be a user operable and selectable network or device icon, which, when selected by a user, causes a processing element, such as CPU 110 as illustrated in FIG. 1, to perform actions, such as, for example, display of information profile screen 220.

Information profile screen 220 optionally contains user-fillable loci for information pertaining to user, such as, user name, a user phone number, and a user address. User-fillable loci can optionally be populated from user profile 222, which can be stored, in a device storage location, such as user profile storage 132, as illustrated in FIG. 1. Additional embodiments contemplate user profile 222, for example, optionally accessible from a remote storage location, creatable upon each selection of help icon 210, and creatable from internal and/or external information collected from the network device operating application 200. In embodiments where user profile 222 is created without positive or negative action of a user, for example, where profile information is created based on the operations of a network device actively and/or passively collecting internal and/or external information, user profile 222 is contemplated to be built from any combination of environmental, human, and/or electrical- based factors, such as existing contact information contained and parsed in network device, fingerprint(s) and/or retinal scan of user, spatial location of network communication access(es) to the network device, and the like.

Information profile screen 220 additionally can contain user-fillable loci for pertaining to an affiliate user profile 224, such as, affiliate user name, an affiliate user phone number, and an affiliate user address. User-fillable loci can optionally be populated from affiliate user profile 224, which can be stored, in a device storage location, such as affiliate user profile storage 134, as illustrated in FIG. 1. Where affiliate user profile 224 is stored on a user network device, it is contemplated that any of a number of affiliate user profiles 224 can and will be stored as described in affiliate user profile storage 134, and displayed in a list matrix which is selectable by the user and populating the profile onto information profile screen 220 upon selection.

For the present embodiment, it is contemplated that a user provides the information needed to sufficiently define affiliate user profile 224, however, for additional contemplated embodiments, affiliate user profile 224 to be built from any combination of external sources, such as authorization communication signal sent from an affiliate user device, environmental, human, and/or electrical-based factors, such as existing contact information contained and parsed in network device, and the like.

Geographical locator icon 230 can be a user operable and selectable network or device icon, which, when selected by a user, causes a processing element, such as CPU 110 as illustrated in FIG. 1, to perform actions, such as, for example, create at least one of a geographical location marker for user network device 232 or a geographical location marker for affiliate user device 234. In this embodiment, as illustrated in FIG. 2, operation of geographical locator icon 230 contemplates the activation and processing of a network device feature, such as GPS 154, as illustrated in FIG. 1 and defined above, alone or in combination with any one of a combination of other geo-positioning mechanisms, including, but not limited to, triangulation, assisted GPS (AGPS), E-OTD, CI, SAT, ETA, BSS or the like, to further determine the physical location of user network device on the surface of the Earth which is operating application 200.

In additional embodiments, it is contemplated that a user selecting geographical locator icon 230 will initiate an independent location determination process, for example, active and/or passive collection of external data via the network device. In one example, still or video images can be collected by activation of a device camera and location determined based on comparison of captured image(s) to a location information database. Further embodiments contemplate a user speaking the name of the location, or descriptive information relating to the surroundings, and comparison of this description against a descriptor information database. By way of example, the location(s) determined via this process may optionally be compared against national and international mapping databases, such as the GIS Survey, Google Maps, Garmin Marine Maps and the like, to assign latitude and longitude for additional locational recognition.

Signal modulator 240 creates a message signal which contains any combination of user profile 222 information, affiliate user profile 224 information, geographical location marker for user network device 232 information, geographical location marker for affiliate user device 234 information. Signal transmitter 250 transmits the created message signal to a switch server 260.

Switch server 260 can be any computing device, for example, any format of application server, individually or in cluster configuration(s), which contains enough computing power and communication pathway accesses so as to be functionally compatible with application 200, the necessity for fast processing and communication speeds, additionally to functionally communicate with PSAPs.

Analyzer 270 operates on the message signal to determine the content of the message signal using, for example, any combination of mathematical, statistical, computational, heuristic, and linguistic, and formalist algorithms and methods to analyze the signal for its contents. Analyzer 270 can optionally contain components (not shown), to particularly or generally analyze the message signal for audio, speech. Image, video, wireless communication, and/or feature extract such as speech recognition and image understanding. Analyzer 270 can be comprised of any combination of analog or digital filters, samplers, converters, compressors and/or other processors that would be functionally compatible to analyze a message signal originating from application 200.

Additionally, analyzer 270 can further include components, for example, authenticator 272, which can operate on the analyzed single to authenticate the contents of the signal, and locator 272, which can determine a location of a public safety answering point based on the analyzed signal content.

Authenticator 272 operates on the message signal to determine origin and other identity factors, so as to determine if a legitimate message signal has been produced from use of application 200, including but not limited to, any information provided from user profile 222 and/or affiliate user profile 224, and any passively or actively collected information inherent to the message signal, such as header information, or any context or content required for the message signal to be received by switch server 260. Authenticator 272 can include, and/or incorporate, any authentication and authorization method, including but not limited to, digital identity authorization, multifactor authorization, secure remote password protocol, public key cryptography and the like.

Locator 272 operates on the message to analyze the geographical location marker for user device 232 and geographical location marker for affiliate user device 234. Analysis of the geographical location markers 232, 234 can include, but is not limited to geocoding, address interpolation, point-level geocoding, geotagging, geolocation, c-square, quarter degree grid cells (QDCG), georeferenced, or any other functionally necessary method to determine the physical location defined by geographical location markers 232, 234, since the defined location determines which, if any, public safety answering points (PSAPs) are available to the user.

Locator 272 additionally operates to create and provide for transmission a signal containing an error message or unknown location message where one of geographical location markers 232, 243 fails to be locatable using any one or combination of locating algorithms and/or methods operational in locator 272. The error message signal can return to application 200 for display of a prompt for the user to click onto the information profile screen 220 to enter new location information or re-select geographical locator icon 230 to create a new geographical location markers 232, 234.

Locator 272 additionally operates to determine and analyze the location of public safety answering points (PSAPs). Location of PSAPs can be determined by locator 272 using any method of location analysis, such as GPS, geolocation, and the like.

Communicator 280 is operable to initiates a communication pathway for the conference call(s) between any the user, the affiliate user and the PSAP. The communication signal transmitted from communicator 280 can format of telecommunications carrier signal, including signals that transmit voice data, still image data, video data and the like, for example, electromagnetic waveforms, spread spectrum, ultra-wideband, sideband and division multiplexed frequencies. Communication methods may include those described with reference to FIGS. 1, 3 and 4, may also include a wired network method, a wireless network method, digital and/or analog, VoIP or other internet-based and/or cloud-based communication method, or any combination thereof, non-limited by any functionally reasonable communication method.

FIG. 3 illustrates one embodiments of an environment in which the inventive 911 user device application may be practiced. Not all the components may be required to practice the invention, and variations in the arrangement and type of the components may be made without departing from the spirit or scope of the invention. System 300 includes network 310, wireless network 320, user network devices 330, affiliate user devices 340, public safety answering points (PSAP) 350 and the switch servers 360.

Network 310 can be configured to couple user network devices 330 with other computing devices, including the affiliate user devices 340 directly to user network devices 330, to and through wireless network 320 to user network devices 330 and through wireless network 320 to other network enabled devices. Network 310 can be enabled to employ any form of computer readable media for communicating information from one electronic device to another. Also, network 310 can include the Internet in addition to local area networks (LANs) and wide area networks (WANs), direct connections, such as, for example, through a universal serial bus (USB) port, other forms of computer-readable media, or any combination thereof. On an interconnected set of LANs, including those based on differing architectures and protocols, a router acts as a link between LANs, enabling data communication to be sent from one to another. In addition, data communication links within LANs typically include twisted wire pair or coaxial cable, while data communication links between networks may utilize analog telephone lines, full or fractional dedicated digital lines including T1, T2, T3 and T4, Integrated Services Digital Networks (ISDNs), Digital Subscriber Lines (DSLs), wireless links including, but not limited to satellite links, or other communications links known to those skill in the art. Furthermore, remote computers and other related electronic devices could be remotely connected to either LANs or WANs via a modem and temporary telephone link. In essence, network 310 includes any communication method by which information may travel between computing devices.

Wireless network 320 can be configured to couple user network devices 330 and their components with network 310. Wireless network 320 can included any of a variety of wireless sub-networks that may feature overall stand-alone ad-hoc networks, and the like, to provide an infrastructure-oriented connection for user network devices 330. Such sub-networks may include mesh networks, wireless LAN (WLAN) networks, cellular networks, and any other format of wireless connection.

Wireless network 320 can further include an autonomous system of terminal, gateways, routers, and the like connected by wireless radio links, other bandwidth links and modulators and similar. These connectors can be configured to move freely and randomly and organize themselves arbitrarily, such that the topology of wireless network 320 may change rapidly.

Wireless network 320 may further employ a plurality of access technologies including second (2G), third (3G) generation radio access for cellular systems, Code Division Multiple Access (CDMA), WLAN, Wireless Router (WR) mesh, and similar configurations. Access technologies such as 2G, 3G and future access network may enable wide area coverage for mobile devices, such as embodiments of user network devices 330, with various degrees of mobility. For example, wireless network 320 may enable a radio connection through a radio network access such as Global System for Mobil Communication (GSM), General Packet Radio.

Services (GPRS), Enhanced Data GSM Environment (EDGE), Wideband Code Division Multiple Access (WCDMA), and similar. In essence, wireless network 320 may include virtually any wireless communication mechanism by which information may travel between user network devices 330 and another computing device, network or similar.

One embodiment of a user network device 330 is described in more detail above, in conjunction with FIG. 1. Generally, however, user network devices 330 and affiliate user devices 340 may include virtually any portable computing device capable of receiving and sending data over a network, such as network 310 and wireless network 320. User network devices 330 and affiliate user devices 340 may also be described generally as a user device that is configured to be portable. Thus, user network devices 330 and affiliate user devices 340 may include virtually any portable computing device capable of connecting to another computing device and receiving information. Such devices include portable devices, for example, mobile phones, smartphones, display pages, Radio Frequency (RF) devices, Infrared (IR) devices, Near Frequency Communication (NFC) devices, Personal Digital Assistants (PDAs), handheld computers, tablets, laptop computers , wearable computers, computer peripheral accessories, Integrated devises combining one or more of the preceding devices, and the like. As such, user network devices 330 and affiliate user devices 340 typically range widely in terms of capabilities and features. For example, a mobile phone may have a numeric keypad and a few lines of monochromatic LCD display on which only text may be displayed. In another example, a web-enabled mobile device such as a tablet may have a touch sensitive screen, a stylus and several lines of color LCD display in which both text and graphics can be displayed.

User network devices 330 and affiliate user devices 340 may include virtually any computing device capable of communicating over a network to send and receive information, including communicating social networking information, performing various online activities, including trading data with other user entity devices, and similar. The set of such devices that can be used for user network devices 330 and affiliate user devices 340 include devices that typically connect using a wired or wireless communications mediums, such as, for example, personal computers, multiprocessor systems, microprocessor-based or programmable consumer electronics, network PCs, and the like. In one embodiment, at least some of the user network devices 330 and affiliate user devices 340 can operate over wired and/or wireless networks. User network devices 330 and affiliate user devices 340 can also include virtually device usable as a television device, as many newer models of these devices include a capability to access and/or otherwise communicate over a network such as network 310 and/or wireless network 320. Additionally, user network devices 330 and affiliate user devices 340 can also be a traditional wired telecommunications handset, if that traditional handset has a microphone, a speaker and at least one connection to a communications pathway. Moreover, user network devices 330 and affiliate user devices 340 may access various computing applications, including a browser, cigar band recognition interface, and/or any other web-based application.

A web-enabled user network device 330 may include a browser application that is configured to receive and to send web pages, web-based communications, and any other data. The browser application can be configured to receive and display graphics, text, multimedia and similar functionalities, employing virtually any Web-based language, but not limited to, a wireless application protocol (WAP) and similar In one embodiment, the browser application can be enabled to employ Handheld Device Markup Language (HDML), Wireless Markup Language (WML), WML-Script, JavaScript, Standard Generalized Markup Language (SMGL), HyperText Markup Language (HTML), eXtensble Markup Language (XML) and any other programming language that is functionally compatible, to display and send information. In one embodiment, a user of the user network device 330 can employ the browser to perform various activities over a network; however, another application besides the browser can also be used to perform various online activities.

User network devices 330 and affiliate network device 330 can also include at least one other user application that is configured to send and receive content from and to another computing device. The user application can include a capability to provide and receive textual content, graphical content, audio content, and any other type of transmittable information. The user application can further provide information that identifies itself, including, but not limited to, a type capability, name and any other functionally necessary descriptive information. In one embodiment, user network devices 330 can uniquely identify themselves through any of a variety of mechanisms, for example, including but not limited to, a phone number, Mobile Identification Number (MIN), an Electronic Serial Number (ESN), a Global Positioning System (GPS) identifies, or other mobile device identifier. In additional embodiments, the information can also indicate a content format that the mobile device is enabled to employ. For example, such information can be provided in a network packet, or any other data transmission format, sent to the switch server 360 or any other interface.

In further embodiments of the present system, user network devices 330 have the option to include peripheral devices, which may be, for example, virtually any computing and/or receiving device capable of receiving communicating over a network, including receiving image recognition information, performing various online activities, including receiving data from other user devices, peripherals and similar. The set of such devices that can be used for user devices include devices that typically connect using a wired or wireless communications mediums, such as, for example, microprocessor-based or programmable consumer electronics, and the like. In one embodiment, at least some of the user peripheral devices can operate over wired and/or wireless networks. These devices can include, for example, but are not limited to, mobile phones, smartphones, display pagers, Radio Frequency (RF) devices, Infrared (IR) devices, Near Frequency Communication (NFC) devices, Personal Digital Assistants (PDAs), handheld computers, tablets, laptop computers, wearable computers, general computer peripheral accessories, integrated devices combining one or more of the preceding devices, and the like. User peripheral devices can also include virtually device usable as a television device, as many newer models of these devices include a capability to access and/or otherwise communicate over a network such as network 310 and/or wireless network 320. User peripheral devices can also include any telecommunications device, for example, a traditional, wired handset that has at least a microphone, a speaker and a connection to a communications pathway. Communications to these devices can occur using networks and/or methods as described above.

Communication media typically embodies computer-readable instructions, data structures, program modules, or other transport mechanism and includes any information delivery media. By way of example, and not in limitation, communication media can include wired media such as twisted pair, coaxial cable, fiber optics, wave guides, and other wired media and wireless media such as acoustic, Radio Frequency (RF), Near Frequency Communication (NFC), infrared, and other wireless media. PSAP 350 is generally is a call center responsible for answering calls to an emergency telephone number for police, firefighting, and ambulance services. Trained operators are also usually responsible for dispatching these emergency services. In this exemplary system embodiment, PSAP 350 can receive call transmission signals from wired and/or wireless network communication devices, however, generally, PSAP 350 receives communication requests over a wired communication network. Additionally, PSAPS 350 can optionally use voice broadcasting where outgoing voice mail and/or other messaging can be sent to many phone numbers at once, in order to alert people to a local emergency such as a chemical spill.

One embodiment of switch server 360 is described in more detail above, in conjunction with FIG. 2. Briefly, switch server 360 may include any one or more computing devices capable of connecting to network 310 to enable user network devices 330 and affiliate user devices 240 to enter into a conference call or like communication method between each other as well as between PSAP 350. In one embodiment, switch server 360 can further enable one or more user network devices 330 to access and/or download the 911 user device application, illustrated in FIG. 2, for use on the user network devices 330. In one embodiment, the application is configured to enable a user to create and/or store user profiles and affiliate user profiles, create and/or store geographical location markers, and initiate help communication signals which can then be analyzed by switch server 360 and transferred to PSAP 350.

In one embodiment, the data collected for can stored on user network devices 330, however, in another embodiment, the data may be stored at least in part on switch server 360, cloud-based storage platforms, and/or any other functionally compatible storage medium.

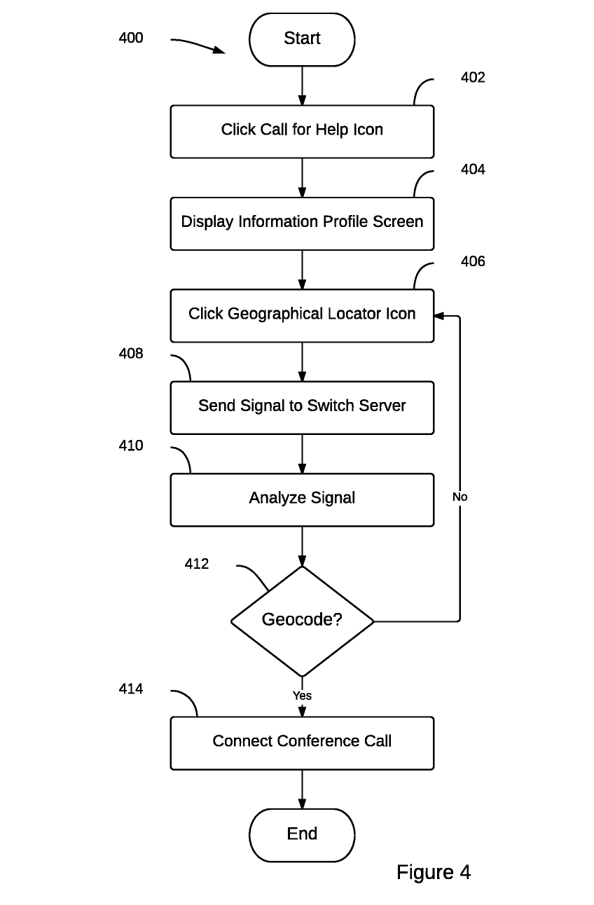

The operation of certain aspects of the invention will now be described with respect to FIG. 4. FIG. 4 illustrates a logical flow diagram generally showing one embodiment of a process for a user to initiate conferenced communication between the user, an affiliate user and a PSAP, regardless of the immediate location of one of the user, the affiliate user or the PSAP, through the devices and systems described above. As noted elsewhere, process 400 of FIG. 4 can be implemented in part, or whole, within network user devices 330 of FIG. 3, and/or one or more of the user network devices 100 of FIG. 1. Furthermore, it is contemplated that steps be added and/or removed from Process 400. The following detailed description is, therefore, not to be taken in a limiting sense, and various embodiments envisioned by adding and/or removing steps in the process may be readily combined, without departing from the scope or spirit of the invention. Additionally, the written description below pre-supposes that a user of the process will be in such as to require communications with a PSAP so that emergency services can be dispatched to either the user or at least one affiliate user.

Process 400 begins after a start block 402, at 404, where a call for help icon is displayed for use by user. This icon may be displayed on a mobile device screen, such as on a smart phone where a user would tap the icon with a digit or stylus, for example, or on a laptop or desktop computing device where the icon is selectable via mouse click. In additional embodiments, the icon may be displayed on the screen of a telecommunications device, such as a wireless or wired phone handset, where a toggle may be necessary to select said icon. However, it is contemplated as part of this process that the icon is selectable in any medium or method as is functionally necessary a user of a specific network device to select such icon as needed to work within the system requirements of that network device.

Optionally, at 404, a user entity sets up a user profile identity and/or account. Commonly an online identity, internet identity, or internet identify is generally user identification for billing and product order history, for example, but also for other purposes, including but not limited to, identities for online communities and account-based websites. It can also be considered as an actively constructed presentation of oneself. Although some users prefer to use real names online, some Internet users prefer to be anonymous, identifying themselves by means of pseudonyms, which reveal varying amounts of personally identifiable information.

At 404, it is contemplated that a user profile be created by a user, for example, containing information about the user, such as user name, user phone number, and user address. Additional embodiments of the user profile may include such information, for example, health information, allergies, preferred transportation methods, and the like. Creation of a user profile may also optionally include creating an affiliate user profile, for example, containing information about an affiliate user associated to user, such as affiliate user name, at least one affiliate user phone number, at least one affiliate user address. In this context, the affiliate user could be a whom the user may wish to contact during an emergency situation, such as a family member, child, or spouse, or the affiliate user may be a person who would require the user to contact emergency services on their behalf, for example, an elderly relative, parent or grandparent.

At 404, the user has the option of creating a user account according to many methods and embodiments. For example, upon downloading the application to a mobile device, the user can be prompted to create the user account, and/or update an existing using account. Additional embodiments include the option for a user entity to use a laptop computer or desktop computing device to log onto a website using a browser application, and thereby creating an account through a similar method however different the interface content and/or request methods are. Additional methods and embodiments envisioning a user entity creating and/or changing, editing and/or otherwise managing a user account in any manner that is reasonably compatible with the incident description herein.

At 406, by selecting the call for icon, the user initiates display of an information screen further comprising display of user name, a user phone number, a user address, if this information has been already set up as part of the user profile, or optionally locations are displayed and left open for the user to enter such information, for example, by typing using a physical or virtual keyboard or keypad. Additionally it is contemplated that the information screen further display at least one affiliate user name, at least one affiliate user phone number, and at least one affiliate user address. Optionally, the affiliate user information can displayed by affiliate user profile, for example, in a list matrix which is selectable by the user and populating the information screen upon selection.

It is contemplated for additional embodiments where information locations and/or loci are left blank, an error message may be displayed requiring user to enter such information that is necessary for purposes of authentication of the user and/or affiliate user.

At 406, the information display screen can also display a geographical locator icon. The geographical locator icon is described above, in FIG. 2, in reference to element geographical locator icon 230, and therefore, will not be discussed in detail here.

At 408, the user can select geographical locator icon to create at least one geographical location marker for user or a geographical location marker for at least one affiliate user. The geographical location markers described here as part of this process are similar to those discussed above with reference to FIG. 2, for example, geographical location marker for user network device 232 and geographical location marker for affiliate user device 234, and as such, will not be discussed in detail here.

At 408, if a location marker cannot be created, due to the nature of the location in which the user attempts to create such marker, for example, in a densely populated urban area or in a highly unpopulated area, including but not limited to, a dense forest area, a desert, a mountainous region, and/or on a body of water, the user may be prompted to enter in a location. It is contemplated in additional embodiments that additional methods of active and passive location information may be collected, for example, by visual image, image and/or audio description of landmarks or surrounds, or device-captured passive information such as communications tower and satellite triangulation, or like, as discussed more fully above in reference to FIG. 1.

At 410, based a signal is created and transmitted that contains at least the user phone number and one or more of the following: an affiliate user phone number, the geographical location marker for the user and the geographical location marker. The signal is transmitted via any functionally necessary communication pathway as described above in FIGS. 1-3 to a switch server.

At 410, it is contemplated that the user not actively initiate this signal transmission one the call for help icon is selected and the geographical locator icon is selected. In this embodiment, a user is commonly in an emergency situation so that unless the location cannot be determined by any known or reasonably knowable mapping algorithm or spatial locator, a user commonly will not know or have the presence of mind to actively know their location such that active selection of transmitting the signal message following activation of the icon(s) would be too onerous.

Additional embodiments further contemplate a process where if a communication, for example, a telephone call is actively occurring between a user and an affiliate user prior to the activation of the call for help icon, either one of the user or affiliate user may select the call for help icon and the profiles information for the user and/or the affiliate user will display as part of the information profile screen and allow for selection of the geographical locator icon for either or both user and/or affiliate user. In these embodiments, it is contemplated that the user is initiating communication for the purpose of receiving emergency services for themselves and/or for the affiliate user. Additional embodiments are contemplated where the affiliate user may be initiating communication for the purpose of receiving emergency services for the user, the affiliate user, both, or neither if at least one more affiliate user profile is available for selection in a list matrix as described above.

At 410, it is contemplated that the party for whom the emergency services are required would be determined prior to submission of the signal to the switch server, so that analysis as described below would not be unduly burdened.

At 412, the switch server analyzes the signal, and this analysis can comprise authenticating user phone number, the affiliate user phone number and geocoding of at least one of the geographical location marker for user and the geographical location marker for the affiliate user. This analysis is illustrated in more detail in FIG. 2, for example, elements analyzer 270, authenticator 272 and locator 274. The analysis methods are described more fully above, and will not be discussed in detail here.

At 412, if the location of either the user and/or the affiliate user cannot be properly located using any of the methods described or contemplated above, it is contemplated that an error be returned from the switch server, which directs the geographical locator screen to display an error message and prompt the user and/or affiliate user to try creating a geographical location marker again or to actively or passively enter location information.

At 414, a conference call to a public safety answering point is initiated based on at least one of the geocoded geographical location markers for the user and/or the affiliate user. The conference call can be over one of or a combination of wireless call pathways, voice over internet protocol (VoIP) call pathways and wireline call pathways. The type of call pathway used may often times be determined by the PSAP which communication will be initiated to, as some locations can only receive one type of communication, whereas additional locations may. The conference call can include information processed and/or presented in any combination of audio, still image, video, and text messaging.

In addition, at 414, the conference call can be between the user, the affiliate user and the public safety answering point. However, it is further contemplated where the affiliate user and the PSAP can have independent, private communication, and that the user and PSAP can have independent, private communication. Though all three of these scenarios are not the optimal communication pathways, all, one or any combination thereof may be necessary depending on a situation.

As described herein, it may be further contemplated that emergency services may also be affiliate users, but not for information inclusion into an affiliate user profile as described here in FIG. 4, but such that a conference call may be initiated between the user, the PSAP and the affiliate user, based on information transmitted via the 911 user device application, analyzed and geocoded through the switch server, and in reference to a call initiated to the PSAP, wherein the PSAP may thereafter be able to conference in the affiliate user, maintain an independent, private contemplated in use in conjunction with individually or in any combination thereof which will create a reasonably functional method, system and device to be of use as a social networking interface. It will be apparent to one of ordinary skill in the art that the manner of making and using the claimed invention has been adequately disclosed in the above-written description of the exemplary embodiments and aspects. It should be understood, however, that the invention is not necessarily limited to the specific embodiments, aspects, arrangement and components shown and described above, but may be susceptible to numerous variations within the scope of the invention.

Moreover, particular exemplary features described herein in conjunction with specific embodiments and/or aspects of the present invention are to be construed as applicable to any embodiment described within, enabled thereby, or apparent wherefrom. Thus, the specification and drawings are to be regarded in a broad, illustrative, and enabling sense, rather than a restrictive one.

Although only a few embodiments of the invention have been described in detail, it should be appreciated that the invention may be implemented in many other forms without departing from the spirit or scope of the invention. It should be appreciated that in some embodiments, one or more of the steps in the methods may be modified, reordered and/or deleted. Therefore, the present embodiments should be considered illustrative and not restrictive and the invention is not to be limited to the details given herein.

What is claimed is:

1. A user network device comprising:
a transceiver to send and receive data over a network; and
a processor that is operative on the sent and received data to perform actions, comprising:
displaying a call for help icon on the user network device, which is operable by a user;
selecting of the icon by the user initiates display of an information screen further comprising at least one of a populated or a fillable loci for a user name, a user phone number, a user address, at least one affiliate user name, at least one affiliate user phone number, at least one affiliate user address, and a geographical locator icon;
selecting geographical locator icon to create at least one of a geographical location marker for the user network device or a geographical location marker for the at least one affiliate user name;
sending a signal containing at least one of the user phone number, the at least one affiliate user phone number, the geographical location marker for the user network device and the geographical location marker for at least one affiliate user, to a switch server;
analyzing the signal by the switch server, further comprising authenticating the at least one user phone number and the at least one affiliate user phone number and geocoding of at least one of the geographical location marker for user network device and the geographical location marker for the at least one affiliate user by the switch server; and
initiating a conference call to a public safety answering point based on at least one of the geocoded geographical location markers between at least one of the user network device, the at least one affiliate user and the public safety answering point.

2. The user network device of claim 1, wherein where the switch server is unable to geocode at least one of the geographical location markers, the user is prompted to click on the user address or the at least one affiliate user address populated or fillable loci to enter new location information or re-select geographical locator icon to create a new geographical location marker.

3. The user network device of claim 1, wherein the performed actions further comprise:
creating a user profile containing at least one of a user name, a user phone number and a user address, said user profile populating the information screen upon selection of the call for help icon;
creating at least one affiliate user profile containing at least one of an affiliate user phone name, an affiliate user phone number and a user affiliate address, said at least one affiliate user profile displayed in a list matrix which is selectable by the user and populating the information screen upon selection; and
clicking on at least one of the populated or fillable loci by the user where loci is empty or contains incorrect user or affiliate user information, the user can optionally change or fill loci.

4. The user network device of claim 1, wherein the performed actions further comprising initiating the conference call via at least one of or a combination of wireless network communication call pathways, voice over internet protocol (VoIP) call pathways and wireline call pathways.

5. The user network device of claim 1, wherein the performed actions further comprise the conference call medium between the public safety answering point and at least one of the user and the at least one affiliate user can be audio, still image, video, and text messaging.

6. The user network device of claim 1, wherein the performed actions further comprise the conference call between the user and the at least one affiliate user can be independent from the conference call with the public safety answering point and the conference call medium can be audio, still image, video, and text messaging.

7. The user network device of claim 1, wherein the performed actions further comprise the conference call between the public safety answering point and the user network device can be independent from the conference call between user network device and the at least one affiliate user entity device and the conference call medium can be any combination of audio, still image, video and text messaging.

8. A system, comprising:
a public safety answering point;
at least one user affiliate entity device; and
a user network device comprising a processor and configured to communicate with the one or more user entity devices over a network, and to perform actions comprising:
displaying a call for help icon on the user network device, which is operable by a user;
selecting of the icon by the user initiates display of an information screen further comprising at least one of a populated or a fillable loci for a user name, a user phone number, a user address, at least one affiliate user name, at least one affiliate user phone number, at least one affiliate user address, and a geographical locator icon; location marker for user network device and a geographical location marker for the at least one affiliate user entity device;
sending a signal containing at least one of the user phone number, the at least one affiliate user phone number, the geographical location marker for the user network device and the geographical location marker for at least one affiliate user entity device, to a switch server;
analyzing the signal by the switch server, further comprising authenticating the at least one user phone number and the at least one affiliate user phone number and geocoding of at least one of the geographical location marker for user network device and the geographical location marker for the at least one affiliate user entity device by the switch server; and
initiating a conference call to the public safety answering point based on at least one of the geocoded geographical location markers between at least one of the user, the at least one affiliate user and the public safety answering point.

9. The system of claim 8, wherein where the switch server is unable to geocode at least one of the geographical location markers, the user is prompted to click on the user address or the at least one affiliate user address populated or fillable loci to enter new location information or re-select geographical locator icon to create a new geographical location marker for the user network device or the at least one affiliate user entity device.

10. The system of claim 8, wherein the network device performs actions further comprising:
creating a user profile containing at least one of a user name, a user phone number and a user address, said user profile populating the information screen upon selection of the call for help icon;
creating at least one affiliate user profile containing at least one of an affiliate user phone name, an affiliate user phone number and a user affiliate address, said at least one affiliate user profile displayed in a list matrix which is selectable by the user and populating the information screen upon selection; and
clicking on at least one of the populated or fillable loci by the user where loci is empty or contains incorrect user or affiliate user information, the user can optionally change or fill loci.

11. The system of claim 8, wherein the network device performs actions further comprising initiating the conference call via at least one of or a combination of wireless call pathways, voice over internet protocol (VoIP) call pathways and wireline call pathways.

12. The system of claim 8, wherein the network device performs actions further comprise the conference call medium between the public safety answering point and at least one of the user network device and the at least one affiliate user entity device can be any combination of audio, still image, video, and text messaging.

13. The system of claim 8, wherein the network device performs actions further comprise the conference call between the user network device and the at least one affiliate user entity device can be independent from the conference call with the public safety answering point and the conference call medium can be any combination of audio, still image, video, and text messaging.

14. The system of claim 8, wherein the network device performs actions further comprise the conference call between the public safety answering point and the user network device can be independent from the conference call between user network device and the at least one affiliate user entity device and the conference call medium can be any combination of audio, still image, video and text messaging.

15. A non-transitory computer readable storage medium having computer-executable instructions, the computer-executable instructions when installed or accessible to a computing device enable the computing device to perform actions, comprising:
displaying a call for help icon, which is operable by a user;
selecting of the icon by the user initiates display of an information screen further comprising at least one of a populated or a fillable loci for a user name, a user phone number, a user address, at least one affiliate user name, at least one affiliate user phone number, at least one affiliate user address, and a geographical locator icon;
selecting geographical locator icon to create at least one of a geographical location marker for user or a geographical location marker for the at least one affiliate user;
sending a signal containing at least one of the user phone number, the at least one affiliate user phone number, the geographical location marker for the user and the geographical location marker for at least one affiliate user, to a switch server;
analyzing the signal by the switch server, further comprising authenticating the at least one user phone number and the at least one affiliate user phone number and geocoding of at least one of the geographical location marker for user and the geographical location marker for the at least one affiliate user by the switch server; and
initiating a conference call to a public safety answering point based on at least one of the geocoded geographical location markers between at least one of the user, the at least one affiliate user and the public safety answering point.

16. The non-transitory computer readable storage medium device of claim 15, wherein where the switch server is unable to geocode at least one of the geographical location markers, the user is prompted to click on the user address or the at least one affiliate user address populated or fillable loci to enter new location information or re-select geographical locator icon to create a new geographical location marker.

17. The non-transitory computer readable storage medium device of claim 15, wherein the actions further comprise:
creating a user profile containing at least one of a user name, a user phone number and a user address, said user profile populating the information screen upon selection of the call for help icon;
creating at least one affiliate user profile containing at least one of an affiliate user phone name, an affiliate user phone number and a user affiliate address, said at least one affiliate user profile displayed in a list matrix which is selectable by the user and populating the information screen upon selection; and
clicking on at least one of the populated or fillable loci by the user where loci is empty or contains incorrect user or affiliate user information, the user can optionally change or fill loci.

18. The non-transitory computer readable storage medium device of claim 15, wherein the actions further comprising initiating the conference call via at least one of or a combination of wireless call pathways, voice over internet protocol (VoIP) call pathways and wireline call pathways.

19. The non-transitory computer readable storage medium device of claim 15, wherein the actions further comprise the conference call medium between the public safety answering point and at least one of the user and the at least one affiliate user can be any combination of audio, still image, video, and text messaging.

20. The non-transitory computer readable storage medium device of claim 15, wherein the actions further comprise the conference call between the user and the at least one affiliate user can be independent from the conference call with the public safety answering point and the conference call medium can be any combination of audio, still image, video, and text messaging.
